(19) United States
(12) Patent Application Publication
(10) Pub. No.: US 2008/0084407 A1
(43) Pub. Date: Apr. 10, 2008

(54) Method of driving display panel

(75) Inventor: Hirokazu Hashikawa, Chuo-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 11/905,839

(22) Filed: Oct. 4, 2007

(30) Foreign Application Priority Data
Oct. 10, 2006 (JP) 2006-276293
Dec. 22, 2006 (JP) 2006-345985

(51) Int. Cl. G09G 5/00

(52) U.S. Cl. 345/205

(57) ABSTRACT

A display panel driving method comprises the steps of setting at least one sub-field of the plurality of sub-field to be a simultaneous address sub-field, and setting at least one sub-field arranged immediately before or immediately after the simultaneous address sub-field to be a line sequential address sub-field, and executing simultaneous address scanning for the simultaneous address sub-field and executing line sequential address scanning for the line sequential address sub-field.

### BACKGROUND OF THE INVENTION

1. Field of the Invention

The present invention relates to a method of driving a display panel of a matrix display scheme, and more particularly, to a method of driving a high-definition display panel.

2. Description of the Related Art

With the transition to the terrestrial digital broadcasting and the progress of high-vision (high-definition) broadcasting, high-definition and large-screen thin televisions are beginning to be pervasive. As such display panels for large-screen televisions, plasma display panels (hereinafter also called the “PDP”) which have a plurality of discharge cells arranged in a matrix form, and liquid crystal panels are being developed with enthusiasm.

The PDP is directly driven by a digital video signal, and the number of levels of gradation of luminance which can be represented thereby is determined by the number of bits of pixel data for each pixel based on the digital video signal. As a method of displaying a PDP in gradation, a sub-field method is known, where a display period of one field is divided into a plurality of sub-fields, each of which is driven.

In the sub-field method, a display period of one field (one frame) is divided into a plurality of sub-fields. Each sub-field includes an addressing period in which each pixel is set one by one in a lighting mode or in an unlighting mode in accordance with pixel data, and a light emission sustaining period in which only pixels in the lighting mode are made to emit light only for a period corresponding to a weighting of the sub-field.

Specifically, for each sub-field, a setting as to whether or not discharge cells are made to emit light in the sub-field is made (addressing period), and discharge cells in the lighting mode alone are forced to emit light for a period allocated to the sub-field (light emission sustaining period). Therefore, in on field, a sub-filed in a lighting state mixes with a sub-field in an unlighting (non-light emission) state, and a halftone luminance is viewed in accordance with the total sum of light emission periods performed in each sub-field.

As described above, in a high-definition display panel for high-definition broadcasting and the like, the addressing period is long due to a large number of display lines. For example, the WXGA standard has 768 lines, and a so-called full-spec high-definition standard, which can display a high-vision (high-definition) signal format for the digital broadcasting as it is, has 1080 lines.

Thus, in order to increase the luminance and the number of levels of gradation for the PDP, the addressing period in the sub-field period must be shortened to increase a period which can be allocated to the light emission period. For example, Japanese Patent Application Laid-open Kokai P2001-312244 (Patent Document 1) discloses a method of reducing an addressing period in a plasma display device by simultaneously writing one-line data into two lines. On the other hand, Japanese Patent Application Laid-open Kokai P2002-182606 (Patent Document 2) discloses a method of simultaneously addressing two lines with the same data for sub-fields which have relatively small light emission weights.

However, when a plurality of lines are simultaneously scanned, the resolution can be degraded, the image cannot be correctly displayed depending on the contents of video data, a disturbed image, a destructed display can occur, and the like.

### SUMMARY OF THE INVENTION

The present invention has been made in view of the point described above, and it is an object of the invention to provide a method of driving a high-luminance, high-resolution and high-definition display panel to reduce an addressing period and avoid a disturbed image and a destructed display, as one example.

A display panel driving method according to the present invention is a display panel driving method for driving a display panel having display cells formed at intersections of a plurality of scanning lines corresponding to display lines with a plurality of data lines arranged to intersect with the scanning lines for every plurality of sub-fields which form part of each frame of a video signal. The method comprises comprising the steps of setting at least one sub-field of the plurality of sub-field to be a simultaneous address sub-field, and setting at least one sub-field arranged immediately before or immediately after the simultaneous address sub-field to be a line sequential address sub-field, and executing simultaneous address scanning for the simultaneous address sub-field and executing line sequential address scanning for the line sequential address sub-field.

### BRIEF DESCRIPTION OF THE DRAWINGS

FIG. 1 is a block diagram showing the configuration of a display apparatus according to a first embodiment;

FIG. 2 is a diagram schematically showing an example of a light emission drive format and address scanning for a PDP according to the first embodiment;

FIG. 3 is a diagram showing an example of image drive data GD produced by performing a conversion process on pixel data, levels of gradation corresponding thereto, light emission drive patterns of discharge cells, and displayed luminance by the light emission drive patterns;

FIG. 4 is a diagram schematically showing a light emission drive format and address scanning in a (j+1)th frame, where an array in the frame in two-line simultaneous scanning (W2A or W2B) and one-line address scanning (W1) is changed with respect to a j-th frame;

FIG. 5 is a block diagram showing the configuration of a display apparatus according to a second embodiment;

FIG. 6 is a diagram schematically showing an example of alight emission drive format for a PDP according to the second embodiment;

FIG. 7 is a diagram showing a sub-field when one-line scanning is mixed with two-line simultaneous scanning in one sub-field;

FIG. 8 is a diagram showing a sub-field when the one-line scanning and the two-line simultaneous scanning are performed in a pattern different from that shown in FIG. 7;

FIG. 9 is a block diagram showing the configuration of a display apparatus according to a fourth embodiment, where a line correlation detector is provided;

FIG. 10 is an exemplary modification of the fourth embodiment, where the line correlation detector detects correlation factors CR1, CR2 for video data corresponding to upper display lines and lower display lines;

FIG. 11 is a block diagram showing the configuration of a display apparatus according to a fifth embodiment, where a drive controller is provided with a sub-frame processor;

FIG. 12 is a diagram schematically showing a light emission drive format and address scanning in a sub-frame according to the fifth embodiment;

FIG. 13 is a diagram schematically showing address scanning in sub-fields in a frame and in each sub-field according to a sixth embodiment;

FIG. 14 is a diagram schematically showing a driving method in an exemplary modification of the sixth embodiment, schematically showing address scanning in sub-fields in one frame and in each sub-field; and

FIG. 15 is a diagram schematically showing address scanning of each sub-field according to a seventh embodiment.

### DETAILED DESCRIPTION OF THE INVENTION

In the following, embodiments of the present invention will be described with reference to the drawings.

### First Embodiment

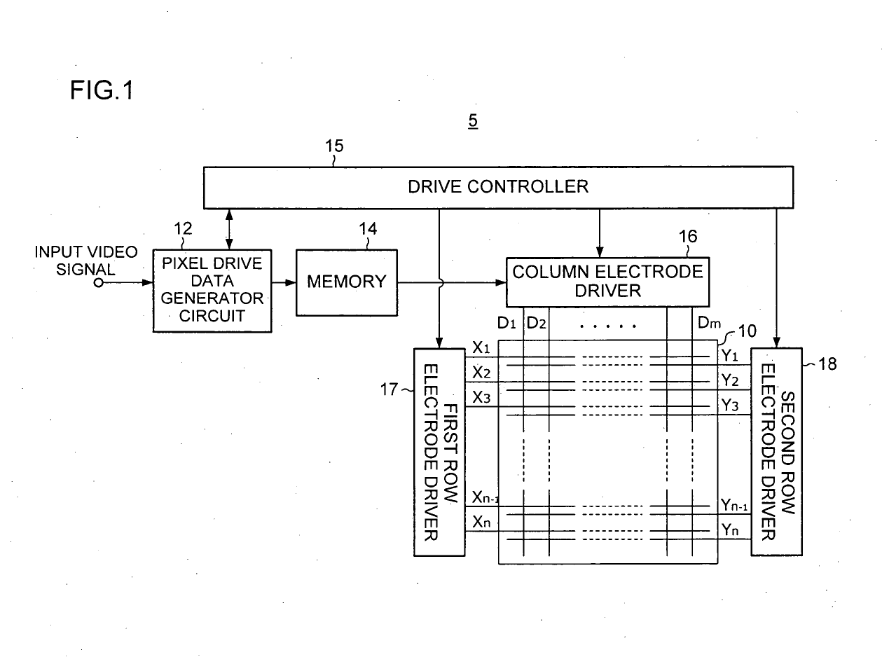

FIG. 1 is a block diagram showing a display device 5 according to the present invention. The display apparatus 5 is provided with a plasma display panel (PDP) 10 as a display device.

More specifically, the display apparatus 5 comprises a pixel drive data generator circuit 12, a memory 14, a drive controller 15, a column electrode driver 16, a first row electrode driver 17, and a second row electrode driver 18.

The PDP 10 comprises column electrodes D1-Dm, and row electrodes X1-Xn and row electrodes Yn-Yn arranged perpendicularly to the column electrodes. In the PDP 10, one pair of the row electrode X and row electrode Y form a row electrode corresponding to one line (one display line). Then, a discharge cell which is a display cell is formed at an intersection of the row electrodes and the column electrode.

When the PDP 10 is a color display panel, the column electrodes D1-Dm may comprise column electrodes D_{1R}, D_{1G}, D_{1B}, D_{2R}, D_{2G}, D_{2B}, . . . , D_{mR}, D_{mG}, D_{mB}, where the column electrodes (D_{jR}, D_{jG}, D_{jB}, j=1−m) are arranged in sequence and applied with light emission drive data pulses of red (R), green (G), and blue (B). In this event, a red discharge cell which discharges and emit light in red is formed at each intersection of each column electrode (D_{jR}) supplied with the light emission drive data pulse of red (R) with the row electrodes X and Y. Likewise, a green and a blue discharge cell which discharge and emit light in green and blue, respectively, are formed at each intersection of each column electrode (D_{jG}, D_{jB}) supplied with the light emission drive data pulses of green (G) and blue (B) with the row electrodes X and Y. In this event, three discharge cells adjacent to each other in a display line direction, i.e., a red discharge cell, a green discharge cell, and a blue discharge cell form one pixel.

The pixel drive data generator circuit 12 of the display apparatus 5 receives an input digital video signal, and converts the signal level to halftone pixel data on a pixel-by-pixel basis. The pixel drive data generator circuit 12 converts the halftone pixel data to pixel drive data GD in accordance with a data conversion table in a manner later described, and supplies the pixel drive data to the memory 14 and drive controller 15.

The memory sequentially writes and stores the pixel drive data GD in accordance with a write signal supplied thereto from the drive controller 15. With such a write operation, when pixel drive data GD11-GDnm have been written for one screen (n lines, m columns), the memory 14 sequentially reads each of the pixel drive data GD11-GDnm on a line-by-line basis in response to a red signal supplied thereto from the drive controller 15, and supplies them to the column electrode driver 16.

The drive controller a synchronizing signal and a variety of timing signal for driving the PDP 10 to the column electrode driver 16, the first row electrode driver 17, and the second row electrode driver 18 in accordance with a light emission drive format, later described, to perform display control. The column electrode driver 16 is connected to the column electrodes D1-Dm, and supplies data pulses (address pulses) to the column electrodes D1-Dm. The first row electrode driver 17 supplies the row electrodes D1-Dm with sustain pulses. The second row electrode driver 18 operates as a scanning driver for supplying the row electrode Y1-Yn with scanning pulses, and also operates as a driver for performing a sustain light emission (sustain discharge) in corporation with the first row electrode driver 17.

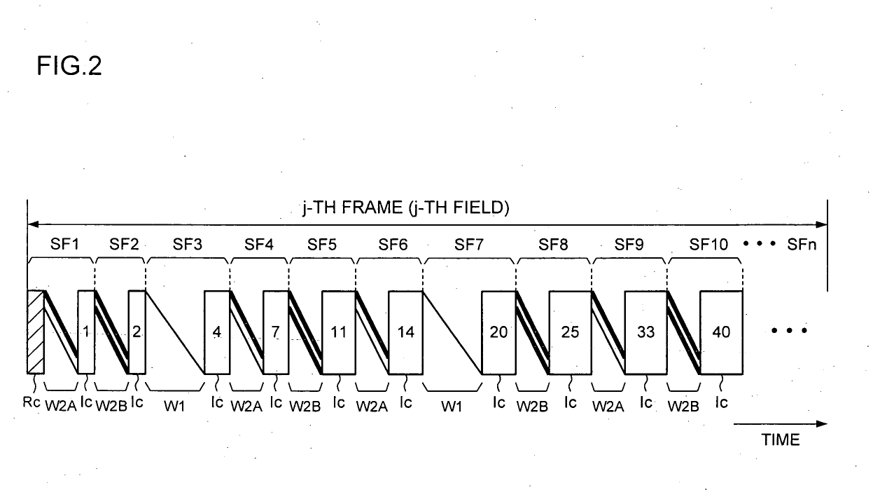

FIG. 2 schematically showing one example of a light emission drive format and an address scanning stage (hereinafter simply called the “address scanning” as well) for the PDP in the embodiment. Specifically, one field (one frame) in a video signal is divided into n sub-fields SF1-SFn, and the PDP is driven sub-field by sub-field. In this event, each sub-field is made up of address scanning W (addressing period) for setting each discharge cell of the PDP to a “lighting discharge cell mode” (hereinafter simply called the “lighting mode” as well) and a “unlighting discharge cell mode” (hereinafter simply called the “unlighting mode” as well) based on an input video signal, and a light emission sustain stage (sustain period) Ic for forcing only discharge cells in the lighting mode for a period (number of times) corresponding to a weight of each sub-field.

The embodiment will be described giving an example in which the driving is performed by an addressing stage W (W1, W2A, W2B) based on a selective erasure method.

Also, only in the first sub-field SF1, a simultaneous reset stage Rc is executed for initializing all discharge cells of the PDP 10 to the lighting mode.

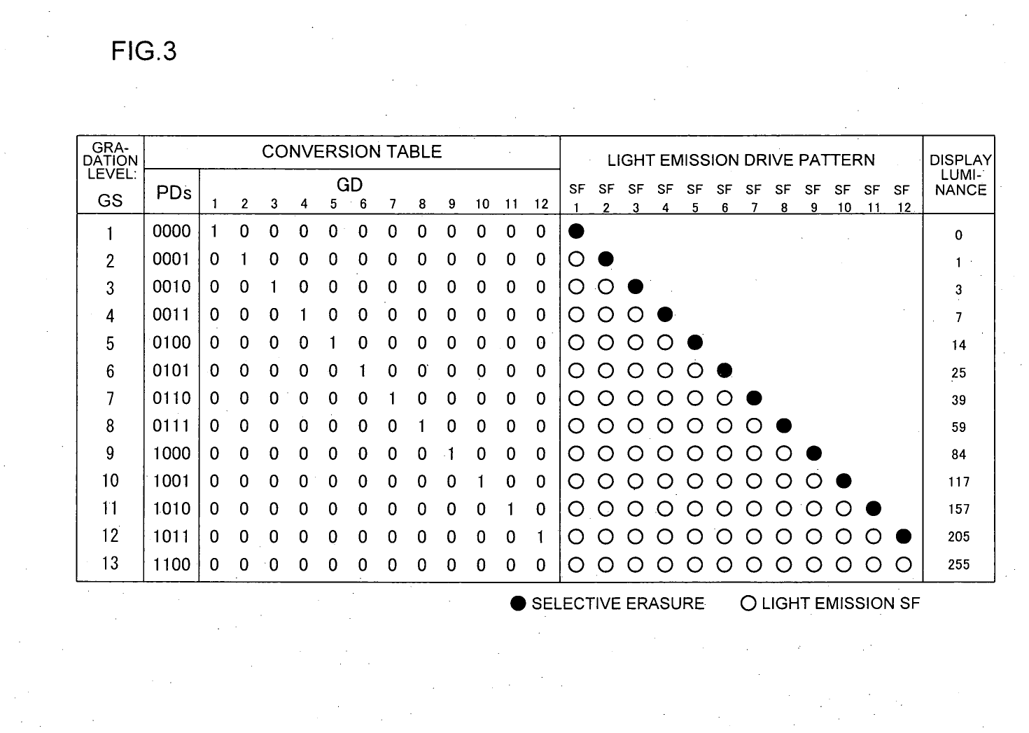

FIG. 3 a diagram showing an example of image drive data GD produced by performing a conversion process on pixel data, levels of gradation corresponding thereto, light emission drive patterns of discharge cells, and displayed luminance by the light emission drive patterns. Specifically, a light emission drive pattern is shown when one field (one frame) is made up of 12 (n=12) sub-fields SF1-SF12, and four-bit halftone pixel data PDs is generated.

The pixel drive data generator circuit 12 receives an input digital video signal, and converts its luminance level to halftone pixel data PDs on a pixel-by-pixel basis. More specifically, the pixel drive data generator circuit 12 performs halftone processing comprising error diffusion processing and dither processing on the input digital video signal to generate the halftone pixel data PDs. The pixel drive data generator circuit 12 converts the halftone pixel data PDs to pixel drive data GD consisting of a first to a twelfth bit in accordance with a conversion table as shown in FIG. 3. Then, each of the first to twelfth bits of the pixel drive data GD corresponds to each of the aforementioned sub-fields SF1-SF12.

In the light emission drive pattern shown in FIG. 3, the number of times of light emission (i.e., number of sustain pulses) in the light emission sustain stage (i.e., sustain period) Ic of each sub-field SF1-SFn indicates the number of times of light emission at 13 levels of gradations corresponding to the four-bit halftone pixel data PDs (FIG. 3), but is not so limited. A desired number of levels of gradation can be set, and the number of times of light emission can be set as appropriate in accordance with each level GS of gradation.

In one field (one frame), the number of times of light emissions is assigned in each sub-field SF2-SFn such that the number of times of light emission assigned to the first sub-field (SF1) is the smallest, and the number of times of light emission for a subsequent sub-field is equal to or larger than the number of times of light emission for a preceding sub-field. Specifically, when NS(k) represents the number of times of light emission in a sub-field SFk (k=1, 2, . . . ,n), the number of times of light emission is assigned such that NS(k)=KS(k+1). Also, the light emission drive pattern is preferably determined in one field (one frame) such that as the level GS of gradation increases, the lighting state is set in succession in the order of the sub-fields, beginning with the first sub-field. Stated in another way, the number of light emissions is assigned such that k sub-fields are set to be the lighting states in succession from the least significant sub-field SF1 to the most significant sub-field (SFk). Then, in one field, it is preferable that a sub-field subsequent to a sub-field which does not involve light emission (i.e., non-light emission sub-field) is not a light emission sub-field (or, all sub-fields subsequent to non-light emission sub-fields are non-light emission sub-fields).

Referring again to FIG. 2, a description will be given of the application of a variety of driving pulses and the operation of address scanning in each sub-field. While the description is given in connection with an example in which the driving is performed in accordance with the selective erasure method, it can be similarly applied as well when it is performed in accordance with the selective write method.

First, in the simultaneous reset stage Rc in the sub-field SF1 in one field (or, one frame) (j-th field), a negative reset pulse RPX is applied to the row electrodes X1-Xn. Simultaneously with the application of the reset pulse RPX, a reset pulse RPy is applied to the row electrodes Y1-Y2. In response to the application of the reset pulses RPX and RPy, all discharge cells of the PDP 10 perform reset discharge, whereby a predetermined amount of wall charge is uniformly formed. In this way, all the discharge cells are initialized to the “lighting mode.”

Next, in the address scanning W2A of the SF1 which is the first (least significant) sub-field, the second row electrode driver 18 which operates as the scanning driver outputs a scanning signal (scanning pulse) for selecting the first scanning line Y1. The column electrode driver 16 applies the column electrodes D1-Dm with data pulses (address pulses) corresponding to logical levels of the pixel drive data, respectively, in synchronism with the application of the scanning pulse to perform the address scanning.

In this event, a weak discharge (selective erasure discharge) occurs only in discharge cells at intersections of row electrodes applied with the scanning pulse with column electrodes applied with pixel data pulse corresponding to the selective erasure (corresponding to “1” in GD of FIG. 3), to selectively erase the wall charges which have remained in the discharge cells. With the selective erasure discharge, the discharge cells in the “lighting mode” transit to the “unlighting mode.” On the other hand, when the pixel data corresponds to a light emission sub-field (corresponding to “0” in GD of FIG. 3), the selective erasure discharge is not triggered, so that the discharge cells remain in the “lighting mode.”

Next, the second row electrode driver 18 outputs a scanning signal (scanning pulse) for selecting a pair of the second and third scanning lines Y2, Y3 to the second and third scanning lines Y2, Y3. The column electrode driver 16 applies the respective column electrodes D1-Dm with data pulses based on address data of the second and third scanning lines Y2, Y3 to perform address scanning. In this event, which of the address data of the second and third scanning lines Y2, Y3 is used can be set as appropriate. For example, as the address data of the column electrodes D1-Dm, any of the address data of the even-numbered scanning line Y2 and odd-numbered scanning line Y3 can be determined for use. Preferably, the setting is performed such that the selective erasure is performed only when both the address data of the even-numbered scanning line (Y2) and odd-numbered scanning line (Y3) corresponds to the “selective erasure” (“1”), and the selective erasure is not performed when only one of the address data corresponds to the “selective erasure” such that the discharge cells remain in the “lighting mode.”

Further, on the scanning lines subsequent to the fourth scanning line Y4, the address scanning is performed based on the address data of an even-numbered scanning line (Y2k) and an odd-numbered scanning line (Y2k+1) (k is a natural number) which are taken in pair, in a manner similar to the second and third scanning lines Y2, Y3.

As described above, preferably, the selective erasure is performed only when both address data of the even-numbered scanning line (Y2k) and odd-numbered scanning line (Y2k+1) correspond to the “selective erasure” (“1”), while the selective erasure is not performed when only one of the address data corresponds to the “selective erasure.”

The foregoing procedure may be represented in a simple manner by Y1, (Y2, Y3), (Y4, Y5), . . . , (Y2k, Y2k+1), . . . on a scanning-by-scanning basis, (where (Y2k, Y2k+1) is a pair in the two-line simultaneous scanning). By such a procedure, the address scanning W2A is executed in the first sub-field SF1. Stated in another way, the sub-field SF1 is a two-line simultaneous addressing sub-field (W2A).

Accordingly, the addressing period of the first sub-field SF1 can be reduced to one-half as compared with that required for sequential scanning performed from one scanning line to another.

Next, in the light emission sustain stage Ic of each sub-field, sustain pulses IP (IP_{X} and IP_{Y}) are applied to the row electrode Xi (X1-Xn) and Yi (Y1-Yn) to provide a sustain discharge for a previously set period.

Here, in the light emission sustain stage Ic, the sustain pulses IP are applied such that the numbers of times of the sustain pulses IP for the respective sub-fields SF1-SF12 are in a predetermined ratio. For example, in the example shown in FIGS. 2 and 3, the ratio of the number of times of the sustain pulses IP in the respective sub-fields are SF1:SF2:SF3: . . . =1:2:4:7: . . . .

In this event, discharge cells in which the wall charges remain, i.e., discharge cells set in the “lighting mode” in the address scanning W2A alone perform sustain discharge each time the sustain pulses IP_{X} and IP_{Y} are applied. Therefore, the discharge cells set in the “lighting mode” sustain a light emission state associated with the sustain discharges the number of times of discharges assigned to each sub-field as mentioned above.

Next in the sub-field SF2 next to the first sub-field SF1, a selective erasure address is executed by a combination of scanning lines different from the address scanning W2A in the sub-field SF1. In the following, the address scanning W2B in the second sub-field SF2 will be described in greater detail.

First, the second row electrode driver 18 outputs a scanning signal (scanning pulse) to the first and second scanning lines Y1, Y2 for selecting the first and scanning line Y1, Y2 as a pair. The column electrode driver 16 applies data pulses to the respective column electrodes D1-Dm based on address data of the first and second scanning lines Y1, Y2 to perform address scanning. In this event, which of address data of the first and second scanning lines Y1, Y2 is used can be set as appropriate. For example, any of address data of the odd-numbered scanning line Y1 and even-numbered scanning line Y2 can be determined for use as address data of the column electrodes D1-Dm.

Preferably, the setting is performed such that the selective erasure is performed only when both the address data of the even-numbered scanning line (Y2) and odd-numbered scanning line (Y3) corresponds to the “selective erasure” (“1”), and the selective erasure is not performed when only one of the address data corresponds to the “selective erasure” such that the discharge cells remain in the “lighting mode.”

Further, on the scanning lines subsequent to the third scanning line Y3, the address scanning is performed based on the address data of an even-numbered scanning line (Y2k−1) and an odd-numbered scanning line (Y2k) (k is a natural number) which are taken in pair, in a manner similar to the second and third scanning lines Y1, Y2.

The foregoing procedure may be represented in a simple manner by (Y1, Y2), (Y3, Y4), . . . , (Y2k−1, Y2k), . . . on a scanning-by-scanning basis, (where (Y2k−1, Y2k) is a pair in the two-line simultaneous scanning). By such a procedure, the address scanning W2B is executed in the first sub-field SF2. Stated in another way, the second sub-field SF2 is a two-line simultaneous addressing sub-field (W2B) associated with a different combination (pair) of simultaneously scanned scanning lines from the address scanning W2A of the first sub-field.

Accordingly, the addressing period of the second sub-field SF2 can be reduced to one-half as compared with that required for sequential scanning performed from one scanning line to another.

The light emission sustain stage Ic of the second sub-field SF2 is similar to that of the first sub-field SF1, where the number of sustain pulses set for the second sub-field SF2 is applied.

Next, in the sub-field SF3, unlike the address scanning W2A, W2B in the sub-fields SF1, SF2, address scanning W1 is performed in accordance with line sequential scanning on a scanning line by scanning line basis. Specifically, the sequential scanning is performed for each scanning line in the order of Y1, Y2, Y3, Y4, Y5, Y6, . . . , Y2k−1, Y2k, . . . . Stated in another way, the sub-field SF3 is a one-line sequential (a-line-at-a-time) scanning sub-field (W1).

The light emission sustain stage Ic in the third sub-field SF3 and the light emission sustain stage Ic in sub-fields subsequent to the fourth sub-field SF4 are similar to those of the sub-fields SF1, SF2 described above, where the numbers of pulses set for the sub-fields SF3, SF4, . . . are applied, respectively.

In the sub-fields subsequent to the sub-field SF4, the aforementioned address scanning W2A, W2B, W1 is executed in combination. For example, as shown in FIG. 2, the respective sub-fields are sequentially arranged in the field (frame) such that the address scanning of the sub-fields SF1, SF2, SF3, SF4, SF5, SF6, SF7, SF8, SF9, SF10, . . . are W2A, W2B, W1, W2A, W2B, W2A, W1, W2B, W2A, W2B,

The setting of the arrangement of the plural line simultaneous address sub-fields (W2A, W2B) (hereinafter, also simply referred to as “simultaneous address sub-fields”) and the one-line sequential address sub-field (W1) (hereinafter, also simply referred to as “line-sequential address sub-field” or “sequential address sub-field”) in one frame (field) described above is made by the drive controller 15. More specifically, the drive controller 15 and executes a setting step to set at least one sub-field of the plurality of sub-fields to be a simultaneous address sub-field, and to set at least one sub-field which appears or arranged immediately before or immediately after a simultaneous address sub-field to be line sequential address sub-field.

Also, display control such as the address scanning, supply of data signals, and the like is performed by the drive controller 15 and the column electrode driver 16, first row electrode driver 17, and second row electrode driver 18 which are controlled by the drive controller 15.

Specifically, one filed includes sub-fields of address scanning (W2A, W2B) which involves simultaneously scanning two lines and performing address using the same data, and sub-fields of address scanning (W1) which performs one-line scanning (line sequential scanning) which performs scanning from one scanning line to another. Also, preferably, the respective sub-fields are provided such that at least two sub-fields of the two-line simultaneous scanning address stage (hereinafter simply called the “two-line simultaneous address stage) (W2A or W2B) are arranged in succession, and a sub-field of at least one-line scanning address stage (hereinafter called the “one-line address scanning) (W1) is arranged between the address scanning arranged in succession.

While the description has been given of an example in which two lines are simultaneously scanned, it can be extended and applied to plural-line simultaneous scanning which simultaneously scans three or more lines. In this event, the address period can be further reduced.

Further, in this embodiment, in the (j+1) field which is the next field to the j-th field (j-th frame), the arrangement in the fields of the two-line simultaneous address scanning (W2A or W2B) and one-line address scanning (W1) are changed from the j-th field.

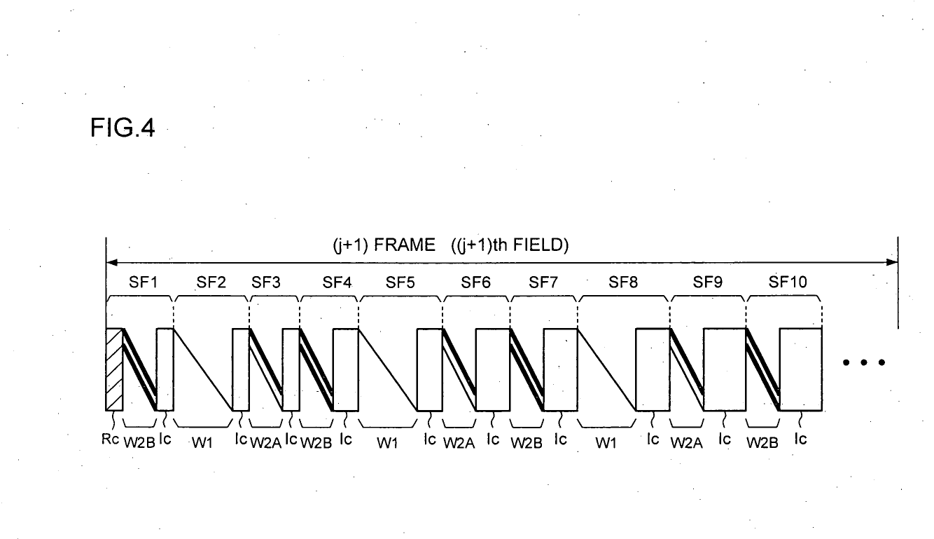

More specifically, in the (j+1)th field, address scanning for each sub-field is arranged as shown in FIG. 4. Specifically, each field is sequentially arranged in the field such that the address scanning of the sub-fields SF1, SF2, SF3, SF4, SF5, SF6, SF7, SF8, SF9, SF10, . . . are W2B, W1, W2A, W2B, W1, W2A, W2B, W1, W2A, W2B, . . . .

Even when the arrangement is changed in the arrangement in the fields of the two-line simultaneous address scanning and one-line address scanning between different fields (frames) as in this embodiment, it is preferable that the number of times of light emission is assigned in each sub-field SF2-SFn such that the first sub-field (SF1) in one field is assigned the smallest number of times of light emission, and a subsequent sub-field is assigned a number of times of light emissions equal to or larger than that of the preceding sub-field (NS (k)=NS(k+1), where NS(k) is the number of times of light emission in a sub-field SFk). Also, preferably, a light emission drive pattern on one field is determined such that as the level GS of gradation increases, the lighting state is entered in the order of the sub-fields beginning with the first sub-field in succession (the light emission drive pattern of FIG. 3).

As described above, a sub-field of the plural-line simultaneous address scanning for simultaneously scanning a plurality of lines, and a sub-field of the one-line address scanning are provided, and a sub-field (sub-fields) of at least one one-line address scanning is provided between a plurality of sub-fields (sub-fields) for performing the address scanning by the plural-line simultaneous scanning. It is therefore possible to provide a high-luminance, high-resolution, and high-definition display apparatus and a driving method which can shorten the address period and extend a period which can be allocated to a light emission period, and do not cause a disturbed image or a destructed display.

### Second Embodiment

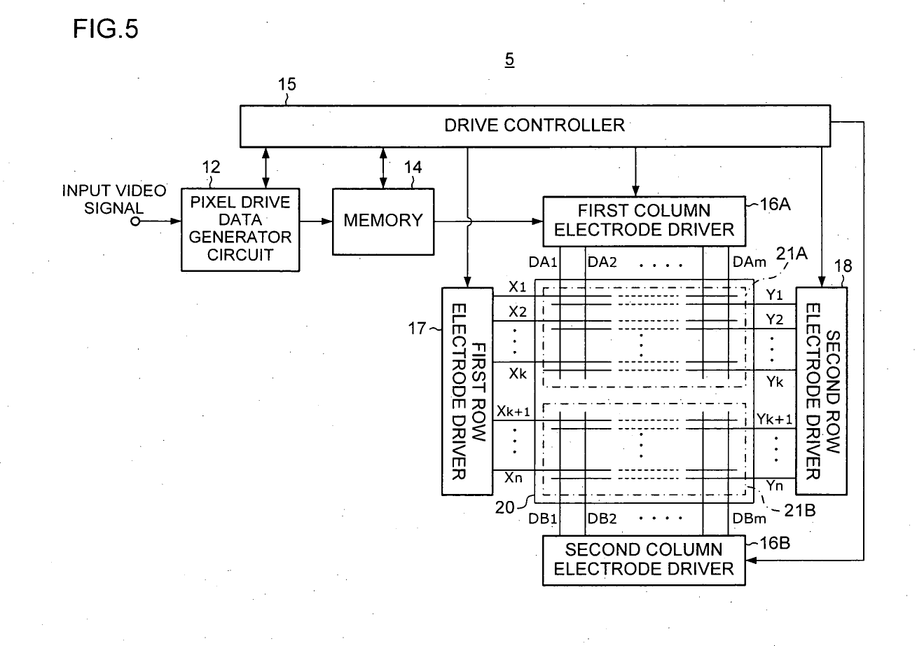

FIG. 5 is a block diagram showing the configuration of a display apparatus 5 in a second embodiment. The display apparatus 5 is provided with a plasma display panel (PDP) 20 as a display device.

The second embodiment differs from the display device 5 of the first embodiment 1 described above in that the column electrodes of the PDP is divided vertically into two in the panel.

More specifically, the column electrodes are divided vertically between a k-throw electrode pair (Kx, Yk) and a (k+1) throw electrode pair (Xk+1, Yk+1) into upper column electrodes DA1-DAm and lower column electrodes DB1-DBm. Then, upper display lines (or line group) 21A is made up of the first to k-th row electrode pairs, while lower display lines (or line group) 21B is made up of the (k+1) th to n-th row electrode pairs.

The first row electrode driver 17 is configured to have the abilities to independently drive the upper display line group 21A (row electrodes X1-Xk) and the lower display line group 21B (row electrodes Xk+1-Xn) and to simultaneously drive the upper display line group 21A and the lower display line group 21B. Likewise, the second row electrode drive 18 which operates as a scanning driver is configured to have the abilities to independently and simultaneously scan the upper display line group 21A (row electrodes Y1-Yk) and the lower display line group 21B (row electrodes Yk+1−Yn).

Further, the first column electrode driver 16A is configured to supply the upper column electrodes DA1-DAm with data pulses (address data) corresponding to logical levels of pixel drive data, respectively, in response to the application of the scanning pulses to the upper display line group 21A (row electrodes X1-Xk). The second column electrode driver 16B in turn is configured to supply the lower column electrodes DB1-DBm with data pulses (address pulses) corresponding to logical level of pixel drive data in response to the application of the scanning pulses to the lower display line group 21B (row electrodes Xk+1-Xn).

Preferably, the upper display lines and lower display lines are configured to divide the total number of lines into two from a viewpoint of the reduction in address period. In other words, the total number of the PDP 20 is preferably divided to satisfy k=n*(1/2), where n is the total number of the PDP 20.

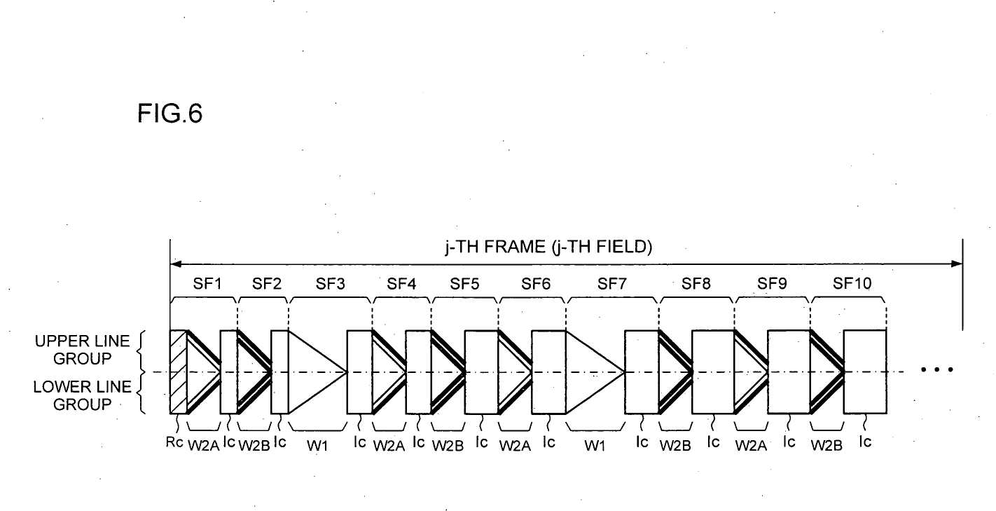

FIG. 6 schematically shows an example of a light emission drive format and address scanning for the PDP 20 in this embodiment. One field in a video signal is divided into n sub-fields SF1-SFn, and the driving is performed in accordance with address scanning comprising a combination of the plural-line simultaneous address scanning for simultaneously scanning a plurality of lines with the one-line address scanning, in a manner similar to the first embodiment. Also, only in the first sub-field SF1, the simultaneous reset stage Rc is executed for initializing all discharge cells of the PDP 10 to the lighting mode, in a manner similar to the first embodiment.

As shown in FIG. 6, in each sub-field, the same address scanning is simultaneously performed for the upper display line group 21A (row electrodes X1-Xk) and the lower display line group 21B (row electrodes Xk+1-Xn).

More specifically, in the first sub-field SF1, the address scanning is performed in accordance with the plural-line simultaneous scanning. More specifically, the second row electrode driver 18 sequentially scans a plurality of lines, i.e., (Y1, Y2), (Y3, Y4), (Y5, Y6), . . . , (Y2k−1, Y2k) for the upper display line group 21A (row electrodes Y1-Yk) in a manner similar to that described in the first embodiment. In this event, the first column driver 16A applies the respective column electrodes DA1-DAm with data pulses based on address data of the plurality of lines in accordance with the plural-line scanning to perform the address scanning.

The second row electrode driver 18 performs the same scanning as that for the upper display line group 21A for the lower display line group 21B (row electrodes Yk+1-Yn) in parallel, simultaneously with the scanning of the upper display line 21A. The second column electrode driver 16B also applies the respective column electrodes DB1-DBm with data pulses in accordance with the plural-line scanning in accordance with the lower display line group 21B in a manner similar to the scanning of the upper display line group 21A.

In this way, the same address scanning (W2B) is simultaneously performed for the upper display line group 21A (row electrodes X1-Xk) and the lower display line group 21B (row electrodes Xk+1-Xn).

In the next sub-field SF2, the same address scanning (W1) is simultaneously performed for the upper display line group 21A (row electrodes (X1-Xk) and the lower display line group 21B (row electrodes Xk+1-Xn). Specifically, the address scanning is performed in accordance with the line sequential scanning in the order of Y1, Y2, Y3, Y4, Y5, Y6, . . . , Y2k−1, Y2k.

In sub-fields subsequent to the sub-field SF4, the aforementioned address scanning W2A, W2B, W1 is executed in combination. For example, as shown in FIG. 6, each sub-field is sequentially arranged in the field such that the address scanning for the sub-fields SF1, SF2, SF3, SF4, SF5, SF6, SF7, SF8, SF9, SF10, . . . are W2B, W1, W2A, W2B, W1, W2A, W2B, W1, W2A, W2B, . . . , respectively.

Specifically, one field includes sub-fields of the two-line simultaneous address scanning (W2A, W2B) for performing the address scanning through the two-line simultaneous scanning, and sub-fields of one-line address scanning for performing the one-line scanning (line sequential scanning). Also, preferably, the respective sub-fields are provided such that at least two sub-fields of the two-line simultaneous scanning address stage (hereinafter simply called the “two-line simultaneous address stage) (W2A or W2B) are arranged in succession, and a sub-field of at least one-line scanning address stage (hereinafter called the “one-line address scanning) (W1) is arranged between the address scanning arranged in succession.

Further, in this embodiment, in the (j+1)th field which is the field next to the field (j-th field), the arrangement of sub-fields of the address scanning in the fields of the two-line simultaneous addressing (W2A or W2B) and one-line address scanning (W1) is changed so as to be different from the j-th field.

Preferably, a setting is made such that the selective erasure is performed only when both address data of an even-numbered scanning line and an odd-numbered scanning line formed inn pair in the two-line simultaneous scanning correspond to “selective erasure” (“1”), while the selective erasure is not performed when only one of the address data corresponds to the “selective erasure,” so that the discharge cells remain in the “lighting mode.”

While the description has been given of an example in which two lines are simultaneously scanned, it can be extended and applied to plural-line simultaneous scanning which simultaneously scans three or more lines. In this event, the address period can be further reduced.

As described above, since the address scanning of the plural-line simultaneous scanning is performed even in parallel with the lower display line group 21B simultaneously with the upper display line group 21A, it is possible to provide a high-luminance, high-resolution, and high-definition display apparatus and a driving method which can further reduce the address period, as compared with the aforementioned embodiment, and do not cause a disturbed image or a destructed display.

### Third Embodiment

In the embodiments described above, the configuration has been shown, where sub-fields of the plural-line simultaneous scanning and sub-fields of the one-line address scanning are mixed in one field.

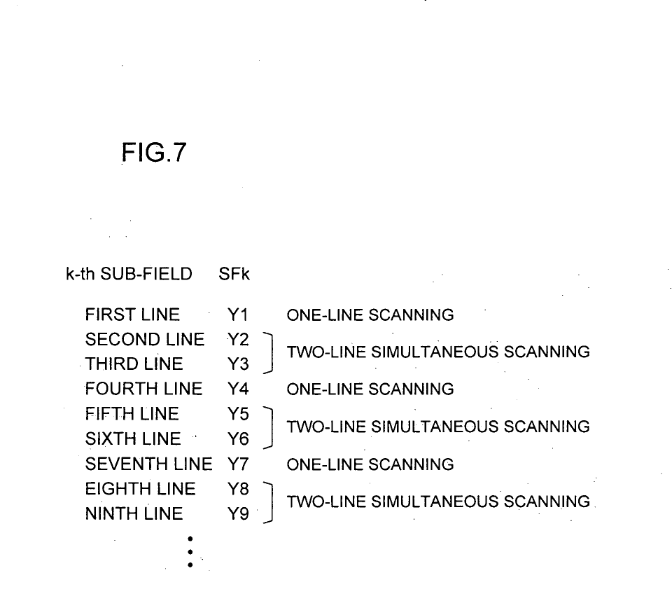

In this embodiment, as shown in FIG. 7, sub-fields of the one-line scanning and sub-fields of the two-line simultaneous scanning are mixed in one sub-field. More specifically, in a k-th sub-field SFk, one-line scanning (display lines: Y1, Y4, Y7, . . . ) and two-line simultaneous scanning ((Y2, Y3), (Y5, Y6), (Y8, Y9), . . . ) are mixed in the configuration. In other words, the scanning is performed in the order of Y1, (Y2, Y3), Y4, (Y5, Y6), Y7, (Y8, Y9), . . . when indicated in the scanning order.

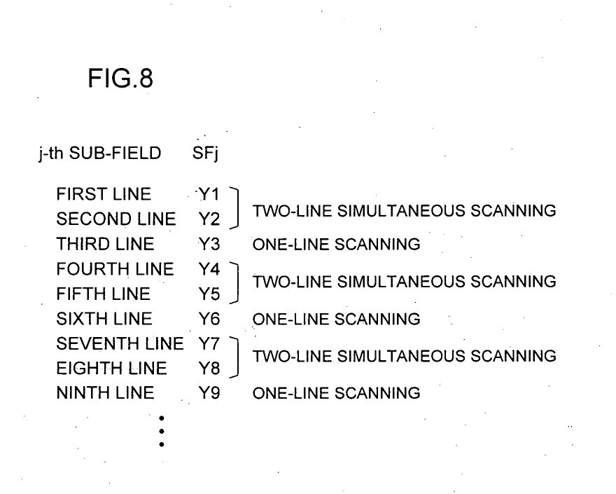

Also, as shown in FIG. 8, in the j-th sub-field SFj, the arrangement pattern of the one-line scanning and two-line simultaneous scanning is changed from the aforementioned k-th sub-field SFk. More specifically, in the j-th sub-field SFj, one line scanning (display lines: Y3, Y6, Y9) and two-line simultaneous scanning ((Y1, Y2), (Y4, Y5), (Y7, Y8), . . . ) are mixed in the configuration. In other words, the scanning is performed in the order of (Y1, Y2), Y3, (Y4, Y5), Y6, (Y7, Y8), Y9, . . . .

For example, the sub-fields in the scanning pattern shown in FIG. 7 and the sub-field in the scanning pattern shown in FIG. 8 may be mixed in one field. Alternatively, the sub-fields in the scanning pattern shown in FIG. 7 and the sub-field in the scanning pattern shown in FIG. 8 may be alternately repeated.

With such a configuration, it is possible to reduce the address period and increase the arbitrariness of scanning to avoid a disturbed image and a destructed display. It is therefore possible to provide a high-luminance, high-resolution, and high-definition display apparatus and a driving method.

### Fourth Embodiment

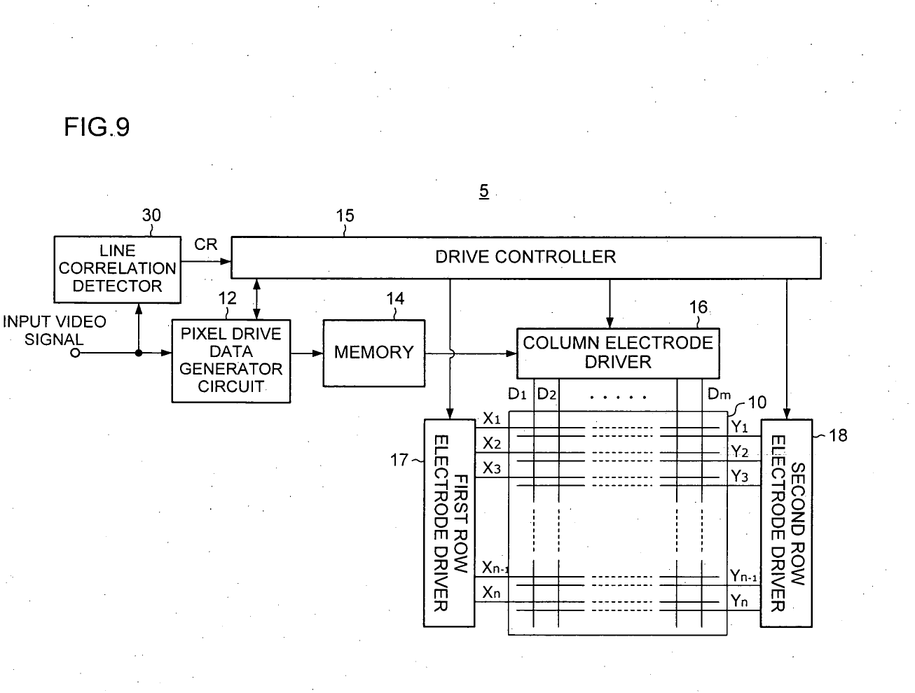

FIG. 9 is a block diagram showing the configuration of a display apparatus 5 in a fourth embodiment of the present invention. The plasma display apparatus 5 is provided with a plasma display panel (PDP) 10 as a display device.

The fourth embodiment differs from the display devices of the embodiments described above in that the display apparatus 5 is provided with a line correlation detector 30.

The line correlation detector 30 detects a correlation value or factor CR of data between display lines based on an input video signal. More specifically, the line correlation detector 30 detects a variation degree or variation factor of display data in the column direction from the input video signal, and detects that the correlation factor is low when the variation degree is large, and that the correlation factor is high when the variation degree is small. Then, the correlation factor CR is supplied to the drive controller 15.

The drive controller 15 establishes an appearance ratio and an appearance pattern (arrangement) of sub-fields by the plural-line simultaneous scan address and sub-fields by the one-line scan address in a field.

With such a configuration, it is possible to increase the number of levels of display gradation as well as to more effectively avoid a disturbed image and a destructed display by the write address control in accordance with the input video signal. It is therefore possible to provide a high-resolution and high-definition display apparatus and a driving method.

Also, the configuration of performing the write address control in accordance with an input video signal by the line correlation detector 30 and drive controller can be applied to the aforementioned embodiments.

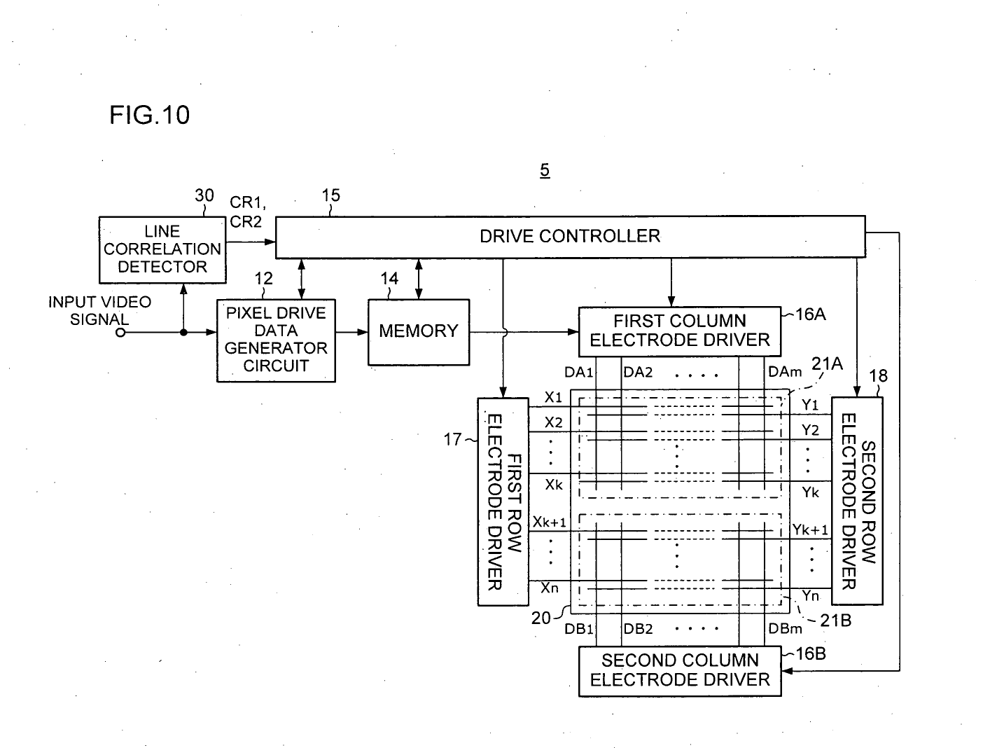

For example, FIG. 10 is a block diagram showing the configuration of the display apparatus 5 when an exemplary modification of this embodiment is applied to the second embodiment.

The line correlation detector 30 detects respective correlation factors CR1, CR2 for video data corresponding to the upper display line group 21A and the lower display line group 21B, respectively.

The drive controller 15 establishes an appearance ratio and an appearance pattern of sub-fields by the plural-line simultaneous scan address and sub-fields by the one-line scan address for the upper display line group 21A and lower display line 21B based on the correlation factors CR1, CR2. Then, the drive controller 15 controls the first row electrode driver 15, second row electrode driver 18, first column electrode driver 16A, and second column electrode driver 16B.

As described above, these driver row electrode drivers 17, 18 and column electrode driver 16A, 16B are configured to have the abilities to supply scanning pulses or data pulses to the upper display line group 21A, the lower display line group 21B, the upper column electrodes DA1-DAm, and lower column electrodes DB1-DBm, respectively, and to drive the upper display panel and lower display panel independently of and simultaneously with each other.

Alternatively, the line correlation detector 30 can be configured to detect the correlation factor CR or CR1, CR2 based on pixel data from the pixel drive data generator circuit 12 instead of an input video signal.

According to such a configuration, it is possible to further shorten the address period as compared with the aforementioned embodiments, and effectively avoid a disturbed image and a destructed display by the write address control in accordance with an input video signal.

### Fifth Embodiment

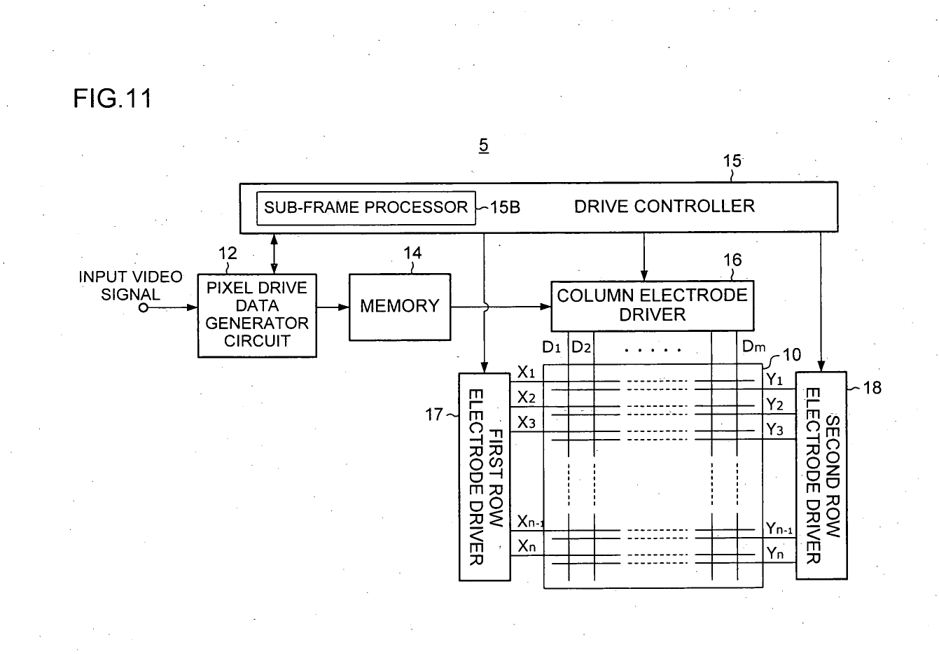

FIG. 11 is a block diagram showing the configuration of a display device 5 according to a fifth embodiment of the present invention. The fifth embodiment differs from the display devices of the embodiments described above in that the drive controller 15 is provided with a sub-frame processor 15B.

The display apparatus 5 is applied, with a cinema signal, for example, at 24 Hz, 25 Hz, 30 Hz or the like as an input video signal.

The sub-frame processor 15B configures a video sub-frames at 48 Hz, 72 Hz, or 96 Hz, which is twice, three times, or four times higher than the frame frequency, for example, 24 Hz of the input cinema signal, respectively, from the input cinema signal. Drive controller 15 controls the column electrode driver 16, first row electrode driver 17, and second row-electrode driver 18 based on the video sub-frame to performs a display on the PDP 10. Here, the drive controller 15 performs the display control using plural-line simultaneous driving in the video sub-frames formed by the sub-frame processor 15B.

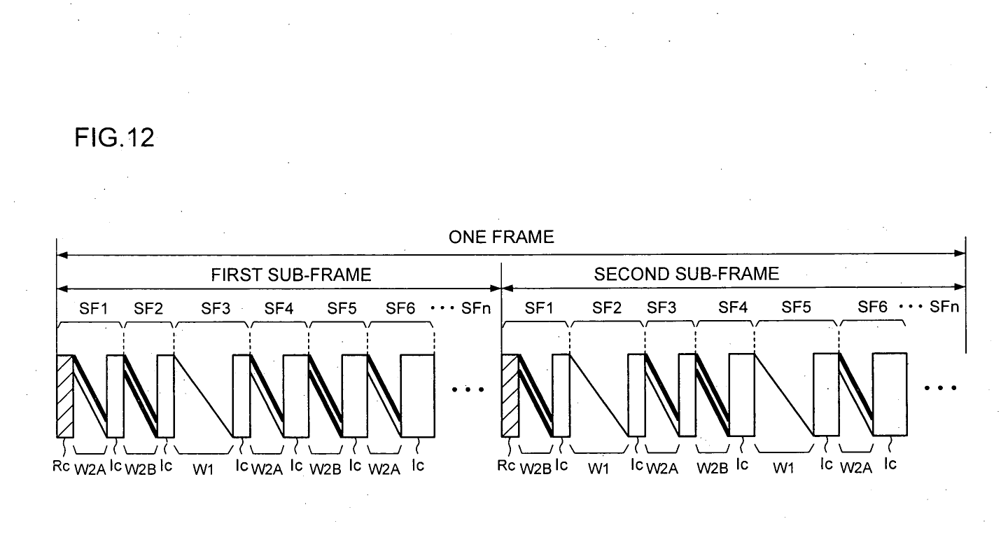

FIG. 12 schematically shows one example of a light emission drive format and address scanning for the PDP in this embodiment. In the following, a description will be given for an example in which twice-faster (for example, 48 Hz) video sub-frames, i.e., two sub-frames (first and second sub-frames) are formed from an input cinema signal (for example, 24 Hz).

In FIG. 12, one frame (one field) in the cinema signal comprises a first and a second sub-frame. In the first sub-frame, sub-fields by the two-line simultaneous address scan (W2A or W2B) and one-line address scan (W1) are arranged, for example, in a similar manner to that shown in the first embodiment (FIG. 2).

Likewise, in the second sub-field as well, sub-fields by the two-line simultaneous address scanning (W2A or W2B) and one-line address scanning (W1) are arranged in a similar manner to that shown in the first embodiment (FIG. 3).

Then, the arrangement of the sub-fields of the two-line simultaneous address scanning and the sub-fields of the one-line address scanning in the second sub-frame is changed with respect to the arrangement of the first sub-frame.

More specifically, in the first sub-frame, the address scannings of sub-fields SF1, SF2, SF3, SF4, SF5, SF6, . . . are sequentially arranged in the sub-frame so as to be W2A, W2B, W1, W2A, W2B, W2A, respectively. On the other hand, in the second sub-frame, the address scanning of sub-fields is sequentially arranged in the sub-frame so as to be W2B, W1, W2A, W2B, W1, W1, W2A, . . . , respectively. In other words, between the video sub-frames, the arrangement of the plural-line scanning is changed and driven.

It is therefore possible to provide a high-resolution and high-definition display apparatus and a driving method which shorten the address period and eliminate a disturbed image and a destructed display.

As an exemplary modification of FIG. 12, the sub-frame arrangement may be configured such that the address scanning arrangement for the sub-fields SF1, SF2, SF3, SF4, SF5, SF6, . . . is W2A, W2B, W1, W2A, W2B, W1, . . . , in the first sub-frame, and the address scanning arrangement for the sub-fields SF1, SF2, SF3, SF4, SF5, SF6, . . . is W2B, W2A, W1, W2B, W2A, W1, . . . , in the second sub-frame.

Alternatively, the sub-frame arrangement may be configured such that the address scanning arrangement for the sub-fields SF1, SF2, SF3, SF4, SF5, SF6, . . . is W2A, W2B, W1, W2B, W2A, W1, . . . , in the first sub-frame, and the address scanning arrangement for the sub-fields SF1, SF2, SF3, SF4, SF5, SF6, . . . is W2B, W2A, W1, W2A, W2B, W1, . . . , in the second sub-frame.

Particularly, when there are a large number of scanning lines, for example, when a video at a relatively low frame frequency is displayed with an image composed of 2,160 pixels vertically and 4,320 pixels horizontally, like a 4K cinema video, flicker can be conspicuous. According to this embodiment, since the sub-frames are configured, and the arrangement of the plural-line driving is changed between the sub-frames, so that this is particularly effective in such a situation. Stated in another way, it is possible to provide a high-luminance, high-resolution, and high-definition display apparatus and a driving method which effectively avoid flicker, reduce the address period, and eliminate a disturbed image and a destructed display.

### Sixth Embodiment

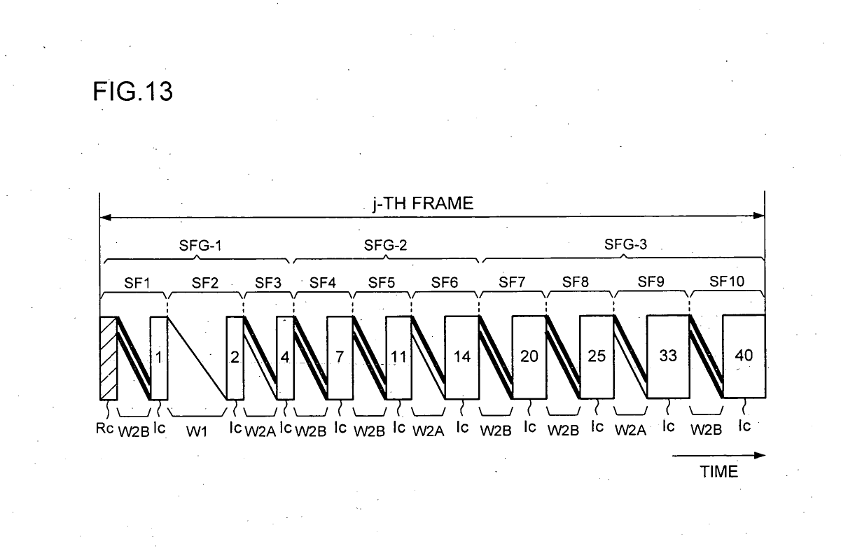

FIG. 13 is a diagram schematically showing a driving method of a sixth embodiment, schematically showing sub-fields in one frame and address scanning in each sub-frame.

In this embodiment, sub-fields which make up one frame are divided into a plurality of sub-field groups each of which comprises a plurality of sub-fields which are respectively arranged in succession. Then, at least one sub-field in each sub-field group is set to be a simultaneous (plural-line) address sub-field, and one sub-field in at least one sub-field group is set to be a line sequential (one-line sequential) address sub-field.

More specifically, as shown in FIG. 13, one frame (j-th frame) is divided into a plurality of sub-field groups SFG, for example, a first to a third sub-field group (SFG-1, SFG-2, SFG-3). In the following, a description will be given in connection with an example in which the one frame (j-th frame) comprises ten sub-fields (SF1 to SF10). Here, the first sub-field group (SFG-1), the second sub-field group (SFG-2), and the third sub-field group (SFG-3) are made up of a plurality of successive sub-fields, first to third sub-fields (SF1, SF2, SF3), fourth to sixth sub-fields (SF4, SF5, SF6), and seven to tenth sub-fields (SF7, SF8, SF9, SF10), respectively.

On sub-field (for example, the second sub-field SF2) in at least one sub-field group, for example, the first sub-field group (SFG-1) in the j-th frame is set to be a line sequential address sub-field (W1). Also, the second and third sub-field groups are set such that the sub-fields SF3-SF6, SF7-SF10 in the sub-field groups are simultaneous address sub-fields (W2A or W2B). The second and third sub-field groups may be set such that at least one sub-field in the sub-field groups is a simultaneous address sub-field.

This embodiment shows a halftone display performed by a similar drive control to the light emission drive pattern shown in FIG. 3 except that one frame is made up of ten sub-frames. Specifically, the ratio of display luminance of the sub-fields SF1:SF2:SF3: . . . :SF10 is set to 1:2:4:7: . . . :40. In other words, on one frame, the first sub-field (SF1) presents the lowest level of gradation, subsequent sub-fields present increasingly higher levels of gradation, and the last sub-field (SF10) presents the highest level of gradation.

Stated in another way, in this frame, the first sub-field group (SFG-1:SF1-SF3) is a sub-field group which is responsible for a low gradation level display; the second sub-field group (SFG-2:SF4-SF6) is a sub-field group which is responsible for an intermediate gradation level display; and the third sub-field group (SFG-3:SF7-SF10) is a sub-field group which is responsible for a high gradation level display. Then, in this embodiment, the sub-field group (SFG-1) which is responsible for the lowest gradation level display is set to include a line sequential address sub-field (W1). Also, FIG. 13 shows that the first sub-field group (SFG-1) alone includes a line sequential address sub-field(W1), while each sub-field of the second and third sub-field groups (SFG-2, SFG-3) is a simultaneous address sub-field, but the second sub-field group and/or the third sub-field group can be set to include the line sequential address sub-field (W1).

While the embodiment has been described in connection with a scenario in which the level of gradation sequentially increases from the first sub-field in the frame, but it is not so limited. The sub-field group of the lowest gradation level display may be set to include the line sequential address sub-field (W1) based on the gradation level of each sub-field group (SFG), i.e., the total sum of the gradation levels of the sub-field in the sub-field group. For example, when the gradation level of the second sub-field group (SFG) in the time base direction, i.e., the total sum of gradation levels of sub-fields in the second sub-field group is set to be smaller and at a lower gradation level than the gradation levels (total sum of the levels of gradation of sub-fields) of other sub-field groups, the second sub-field group which is the lowest gradation level display sub-field group can be set to include a line sequential address sub-field (W1).

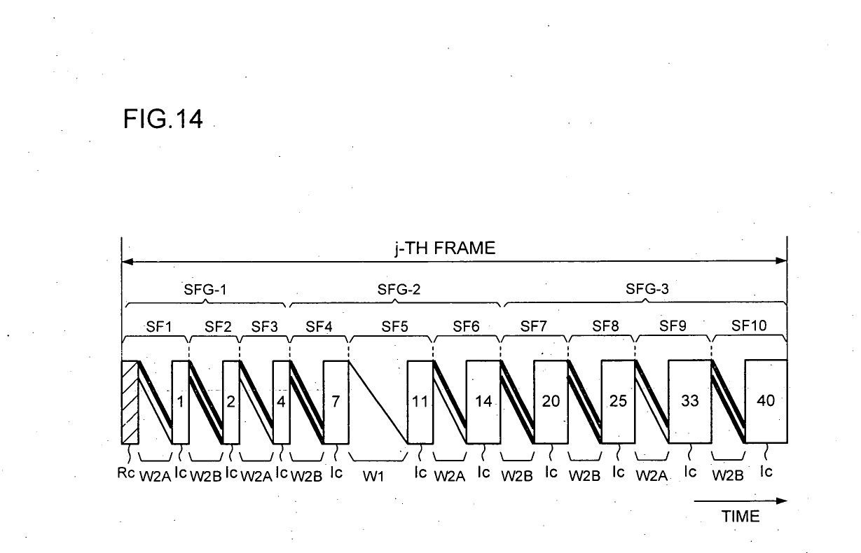

As an exemplary modification of this embodiment, the sub-field group which is responsible for the intermediate gradation level display may be set to include a line sequential address sub-field (W1). An example of such a case is shown in FIG. 14. In the frame, the first sub-field (SF1) presents the lowest gradation level, and the first, second, and third sub-field groups (SFG-1, SFG-2, SFG-3) are sub-fields which are responsible for a low gradation level display, an intermediate gradation level display, and a high gradation level display, respectively, as is the case with the foregoing case.

In this exemplary modification, one sub-field of the second sub-field group (SFG-2) (for example, the fifth sub-field SF5 of the frame) is set to be a line sequential sub-field (W1). Also, the first and third sub-field groups are set such that the sub-fields SF1-SF3, SF7-SF10 in these sub-field groups are simultaneous address sub-fields (W2A or W2B). FIG. 14 shows that the sub-field group (SFG-2) which is responsible for the intermediate gradation level display alone is set to include the line sequential address sub-field (W1), but the first sub-field group and/or third sub-field group may be set to include the line sequential address sub-field (W1).

As described above, sub-fields which make up one frame is divided into a plurality of sub-field groups, and sub-field group which is responsible for a low gradation level display or an intermediate gradation level display is configured to include a line sequential address sub-field. With such a configuration, it is possible to perform a high-resolution and high-definition display without causing a disturbed image or a destructed display in accordance with the type of image such as a pattern of the image and the like. For example, in an image including characters, line portions and the like, particularly, in an image including small characters, oblique lines and the like, it is possible to avoid a problem that the periphery of the character and line is juggy. In such an event, a disturbed image can be avoided by setting to perform the line sequential address in the sub-field groups which are responsible for the low gradation level display and/or intermediate gradation level display in accordance with the pattern and type of the image.

### Seventh Embodiment

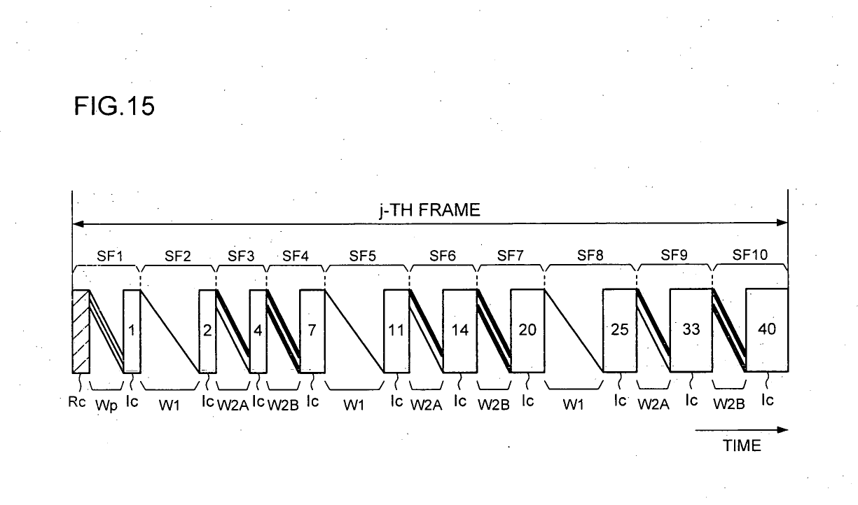

FIG. 15 is a diagram schematically showing a driving method of a seventh embodiment. In this embodiment, two or more sub-fields including a sub-field responsible for the lowest gradation level display in one frame are set to simultaneous address sub-fields, and the number of display lines simultaneously scanned in the simultaneous address sub-field responsible for the lowest gradation level display is set to be larger than the number of display lines simultaneously scanned in the other simultaneous address sub-fields.

More specifically, as shown in FIG. 15, a sub-field (SF1) which is responsible for the lowest gradation level display in one frame, and, for example, sub-fields SF3, SF4, SF6, . . . are set to simultaneous address sub-fields. Then, the simultaneous address sub-fields are set to sub-fields in which the two-line simultaneous address scanning (W2A or W2B) is performed as described in the aforementioned embodiments.

On the other hand, in the sub-field (SF1) which is responsible for the lowest gradation level display, the number of simultaneously scanned display lines is set to be larger than the two-line simultaneous address sub-fields (SF3, SF4, SF6, . . . ). Specifically, in this embodiment, in the lowest gradation level display sub-field (SF1), p-line simultaneous address scanning (Wp) in which p lines are simultaneously scanned, for example, four-line simultaneous address scanning (p=4, W4) is performed.

Specifically, the address scanning is performed collectively for the first to fourth scanning lines Y1-Y4 (one scanning), and the address scanning is performed collectively for four scanning lines as well on scanning lines subsequent to the fifth scanning line Y5. Such a procedure can be represented in brief for each scanning by (Y1, Y2, Y3, Y4), (Y5, Y6, Y7, Y8), . . . , {Y2k−3, Y2k−2, Y2k−1, Y2k), . . . . Through such a procedure, the four-line simultaneous address scanning (W4) is performed for the sub-field (SF1) which is responsible for the lowest gradation level display. Then, in the case shown in FIG. 15, the line sequential address scanning (W1) is performed in the second, fifth, and eighth sub-fields SF2, SF5, SF8, and the two-line simultaneous address scanning (W2A or W2B) is performed in other sub-fields.

When the total number of scanning lines (N) of the PDP 10 is not an integer multiple of four, the address scanning can be performed once per one line, two lines or three lines for part of scanning lines (the residue of N/4). Also, the same is applied to p-line simultaneous address scanning (Wp).

While this embodiment has been described in connection with the lowest gradation level display sub-field in which scanning is performed once per four lines, the number simultaneously scanned line can be set as appropriate in accordance with the pattern and the like of the image, such as scanning performed once per eight lines (eight-line simultaneous address).

With such a configuration, it is possible to perform a high-resolution and high-definition display without causing a disturbed image or a destructed display in accordance with the type of the image such as the pattern of the image. For example, particularly, in an image which has a relatively high proportion at which a high gradation level portion occupies and does not include frequency components with high low gradation level portion, it is possible to provide a high-luminance, high-resolution, and high-definition display apparatus and a driving method which can reduce the address period to extend a period which can be allocated to the light emission period, and does not cause a disturbed image or a destructed display.

### Eighth Embodiment

In the following, an eighth embodiment of the present invention will be described. The fourth embodiment has been described in connection with the configuration in which the display apparatus is provided with the line correlation detector 30, to change the appearance ratio and appearance pattern (arrangement) of plural-line simultaneous address sub-fields and line sequential address sub-fields in a frame based on the correlation factor CR of data between display lines.

The scanning control in accordance with the line correlation factor CR is not so limited. Specifically, a combination of display lines simultaneously scanned in the simultaneous address sub-field can be changed in accordance with the line correlation factor CR.

More specifically, when two-line simultaneous address (W2B is set to be performed for display lines (Y2k−1, Y2k) in pair in a k-th sub-field SFk of a certain frame (j-th frame), the scanning control is changed based on the detected line correlation factor CR such that the pair of display lines is changed to (Y2k, Y2+1) for which the two-line simultaneous address (W2A) is performed. Such a change in the combination of display lines may be made in a sub-field period or in a transition from one sub-field to the next sub-field.

Alternatively, as described in the third embodiment, application can be made to a sub-field in which one-line scanning is mixed with plural-line simultaneous scanning. Specifically, in the third embodiment, a description has been given of a configuration in which the sub-fields of the scanning pattern shown in FIG. 7 is mixed with the sub-fields of the scanning pattern shown in FIG. 8 in one frame.

In this embodiment, the arrangement pattern of the one-line scanning and plural-line simultaneous scanning is changed based on the line correlation factor CR in the sub-field period or every transition from one sub-field to the next sub-field.

With such a configuration, it is possible to perform a high-resolution and high-definition display without causing a disturbed image or a destructed display in accordance with the type of images such as the pattern of the image, still image/moving image, and the like. Also, it is possible to shorten the address period and avoid a disturbed image and a destructed display while increasing the arbitrariness of scanning. It is therefore possible to provide a high-luminance, high-resolution, and high-definition display apparatus and a driving method.

The foregoing embodiments have been described in connection with a so-called selective erasure address method which is employed as an image data writing method which involves forming wall charges in all discharge cells beforehand, and selectively erasing the wall charge remaining in each discharge cell in accordance with pixel data.

However, the present invention can also be applied to a so-called selective write address method which can be employed as a pixel data writing method which involves selectively forming a wall charge in each discharge cell in accordance with pixel data.

Also, while the foregoing embodiments have been described in connection with a display apparatus having a plasma display panel (PDP) given as an example, th the present invention can also be applied to a display apparatus having a display panel such as a liquid crystal panel or the like in a similar manner.

The embodiments described above can be applied in combination. Also, the values and the like shown in the foregoing embodiments are simply illustrative.

What is claimed is:

1. A display panel driving method for driving a display panel having display cells formed at intersections of a plurality of scanning lines corresponding to display lines with a plurality of data lines arranged to intersect with the scanning lines for every plurality of sub-fields which form each frame of a video signal, said method comprising the steps of:
setting at least one sub-field of said plurality of sub-fields to be a simultaneous address sub-field, and setting at least one sub-field arranged immediately before or immediately after the simultaneous address sub-field to be a line sequential address sub-field; and
executing simultaneous address scanning for the simultaneous address sub-field and executing line sequential address scanning for the line sequential address sub-field.

2. The driving method according to claim 1, wherein said setting in said setting step is changed on a frame-by-frame basis in the video signal.

3. The driving method according to claim 1, wherein a combination of display lines in said simultaneous address scanning is changed from one simultaneous address sub-field to another.

4. The driving method according to claim 1, wherein a data correlation factor is detected between display lines of the video signal, and the setting in said setting step is changed in one frame based on the data correlation factor.

5. The driving method according to claim 1, wherein said plurality of scanning lines are divided into an upper display line group and a lower display line group which are address scanned independently of each other.

6. The driving method according to claim 1, wherein said upper display line group and said lower display line group are simultaneously address scanned.

7. The driving method according to claim 1, wherein said sub-fields are arranged such that a lighting period is longer in order from the first sub-field in the frame, and said sub-fields are brought into a light emission state in order from the first sub-field as a gradation level increases.

8. The driving method according to claim 1, wherein said simultaneous address sub-field performs address scanning by address scanning including simultaneous scanning of a plurality of display lines and one-line scanning.

9. The driving method according to claim 1, wherein said display panel is a plasma display panel, the number of sustain pulses are assigned in each sub-field such that the number of sustain pulses of the sub-field is larger than the number of times of light emission in a preceding sub-field, and said sub-fields are brought into a light emission state from the first sub-field as a gradation level increases.

10. The driving method according to claim 1, wherein said display panel is a plasma display panel, and said simultaneous address scanning and said line sequential address scanning are based on a selective erasure method.

11. The driving method according to claim 10, wherein in said simultaneous address sub-field, only when all data corresponding to a plurality of scanning lines to be scanned correspond to a signal which specifies a selective erasure, the selective erasure specifying signal is supplied to the data lines.

12. The driving method according to claim 1, further comprising a step of dividing the frame into a plurality of sub-frames, wherein said step of setting includes setting at least one sub-field of sub-fields of each of the sub-frames to be a simultaneous address sub-field, and setting at least one sub-field arranged immediately before or immediately after the simultaneous address sub-field to be a line sequential address sub-field.

13. The driving method according to claim 12, wherein said setting in said setting step is changed from one sub-frame to another.

14. The driving method according to claim 1, wherein said step of setting includes setting a sub-field arrangement in one frame such that the simultaneous address field is positioned before and after the line sequential address sub-fields.

15. The driving method according to claim 1, wherein said step of setting includes dividing sub-fields which form part of one frame into a plurality of sub-field groups each comprising a plurality of sub-fields arranged in succession, setting at least one sub-field in each sub-field group to be a simultaneous address sub-field, and setting one sub-field in at least one sub-field group to be a line sequential address sub-field.

16. The driving method according to claim 15, wherein said plurality of sub-field groups comprise a sub-field group which is responsible for a low gradation level display, and a sub-field group which is responsible for a high gradation level display, and at lest one sub-field group is a sub-field group which is responsible for the low gradation level display.

17. The driving method according to claim 15, wherein said plurality of sub-field groups comprise a sub-field group which is responsible for a low gradation level display, a sub-field group which is responsible for an intermediate gradation level display, and a sub-field group which is responsible for a high gradation level display, and at lest one sub-field group is a sub-field group which is responsible for the intermediate gradation level display.

18. The driving method according to claim 1, wherein said step of setting includes setting two or more sub-fields including a sub-field responsible for the lowest gradation level display in one frame to be a simultaneous address sub-field, and setting the number of display lines simultaneously scanned in the address sub-field responsible for the lowest gradation level display larger than the number of display lines simultaneously scanned in other simultaneous address sub-fields.

19. The display panel driving method according to claim 1, further comprising the step of detecting a data correlation factor between display lines of the video signal, wherein a combination of display lines simultaneously scanned in the simultaneous address sub-field is changed in accordance with the data correlation factor.
